(19) United States
(12) Patent Application Publication
(10) Pub. No.: US 2024/0389790 A1
(43) Pub. Date: Nov. 28, 2024

(54) MICROWAVE BAKING PAN WITH FULLY-ENCLOSED STRUCTURE

(71) Applicant: HERMAN PENG, FOSHAN (CN)

(72) Inventor: HERMAN PENG, FOSHAN (CN)

(21) Appl. No.: 18/206,162

(22) Filed: Jun. 6, 2023

(30) Foreign Application Priority Data
May 23, 2023 (CN) 202321260738.2

(51) Int. Cl. A47J 36/02

(52) U.S. Cl. CPC A47J 36/027

(57) ABSTRACT

A microwave baking pan with fully-enclosed structure, comprising an upper baking pan, a lower baking pan, an upper baking pan sheath and a lower baking pan sheath, the outer surface of each of the upper and lower baking pans is provided with a microwave absorption layer, and each of the upper and lower baking pan sheaths comprises a face and edge cover part; each of the upper and lower baking pan sheaths is respectively provided with a fishmouth lifting lug on the front and rear side walls; each fishmouth lifting lug is provided with a notch in which an elastic fastener or an L-shaped convex buckle is provided; a positioning column is provided inside an arc-shaped protection lug on each of both sides of the fishmouth hanging lug; each positioning column is provided with a base part and a protruding part, the protruding part extending into the fishmouth lifting lug.

### CROSS-REFERENCE TO RELATED APPLICATIONS

This is a U.S. patent application which claims the priority and benefit of Chinese Patent Application Number 202321260738.2, filed on May 23, 2023, the disclosure of which is incorporated herein by reference in its entirety.

### TECHNICAL FIELD

The present invention relates to the technical field of cookware for microwave ovens, and in particular, to a microwave baking pan with a fully-enclosed structure.

### BACKGROUND

A microwave baking pan (the Chinese Patent Application No. CN201721285469.X, applied by a professional manufacturer of microwave cookware on Oct. 7, 2017) is a cooking utensils dedicated to microwave ovens. This invention discloses an edge cover structure for a microwave baking pan, including an upper baking pan and an upper baking pan sheath, wherein an outer surface of the upper baking pan is provided with a microwave absorption layer, and the upper baking pan is provided in the upper baking pan sheath. The edge cover structure of this invention effectively prevents metal flanges from contacting each other, thereby eliminating an ignition phenomenon caused by metal contact in use of the microwave oven. In this microwave baking pan, an L-shaped convex buckle and an elastic fastener are respectively provided at a baking pan base side, and the elastic fastener is buckled on the L-shaped convex buckle to achieve the alignment and coverage of the upper baking pan and a lower baking pan. However, an alignment and positioning structure for the upper and lower baking pan sheaths is inconvenient to operate, and the elastic fastener is exposed on the outside of the baking pan base, lacking an attractive appearance.

### SUMMARY

An object of the present invention is to provide a microwave baking pan with a fully-enclosed structure that is attractive and elegant in appearance and is prone to closure and positioning of upper and lower baking pans, thereby solving the problems mentioned in the background art.

The technical solution of the present invention is summarized as follows.

A microwave baking pan with a fully-enclosed structure includes an upper baking pan, a lower baking pan, an upper baking pan sheath and a lower baking pan sheath, wherein an outer surface of each of the upper and lower baking pans is provided with a microwave absorption layer, and each of the upper and lower baking pan sheaths includes a face cover part and an edge cover part; each of the upper and lower baking pan sheaths is respectively provided with a fishmouth lifting lug on the front and rear side walls; each fishmouth lifting lug is provided with a notch in which an elastic fastener or an L-shaped convex buckle is provided; a positioning column is provided inside an arc-shaped protection lug on each of both sides of the fishmouth hanging lug of the upper baking pan sheath; and each positioning column is provided with a base part and a protruding part, the protruding part extending into the fishmouth lifting lugs of the lower baking pan sheath.

The fishmouth lifting lugs are engaged to form a runway-shaped contour, and an outer contour of the upper and lower baking pan sheaths while decked and closed is also in a runway shape.

A first sidewall of the protruding part is arc-shaped, and the first sidewall is adapted to an inner contour of the arc-shaped protection lug of the fishmouth lifting lug of the lower baking pan sheath.

The elastic fastener includes a fastening hole part and a telescopic part, the telescopic part being a thin-walled U bend.

The thickness of the thin-walled U bend is ½ to ⅓ of the thickness of the fastening hole part.

Crisscrossed reinforcing ribs are provided on the bottom inside each of the upper and lower baking pan sheathes, and a distance L2 between each of the upper and lower baking pans and the upper end of each reinforcing rib is 1 to 2.5 cm.

The present invention has the following beneficial effects.

1. According to the microwave baking pan with the fully-enclosed structure of the present invention, the fishmouth lifting lugs are provided on the front and rear sides of the upper and lower baking pan sheaths, the positioning columns are provided on the fishmouth lifting lugs of one baking pan sheath and extend into the fishmouth lifting lugs to achieve guided positioning, which facilitates a user to align and close the two baking pan sheaths quickly.

2. Each baking pan sheath of the present invention has a runway-shaped cross-section, and each fishmouth lifting lug is also designed into a runway shape. Therefore, the microwave baking pan is attractive and elegant in appearance and strong in sense of design.

3. A distance between each baking pan and the corresponding baking pan sheath is (L1+L2), which is conducive to uniform heating of the baking pan.

### BRIEF DESCRIPTION OF DRAWINGS

FIG. 1 is an exploded view I of a baking pan of the present invention;

FIG. 2 is a front view of a fishmouth lifting lug of the present invention;

FIG. 3 is an exploded view II of the baking pan of the present invention;

FIG. 4 is a three-dimensional view of the baking pan of the present invention;

FIG. 5 is a cross-sectional view of the baking pan of the present invention; and

FIG. 6 is a longitudinal section view of the baking pan of the present invention.

### DETAILED DESCRIPTION

The following will clearly and completely describe the technical solutions in the embodiments of the present invention in conjunction with the accompanying drawings in the embodiments of the present invention. All other embodiments derived by a person of ordinary skill in the art without creative efforts shall fall within the protection scope of the present invention.

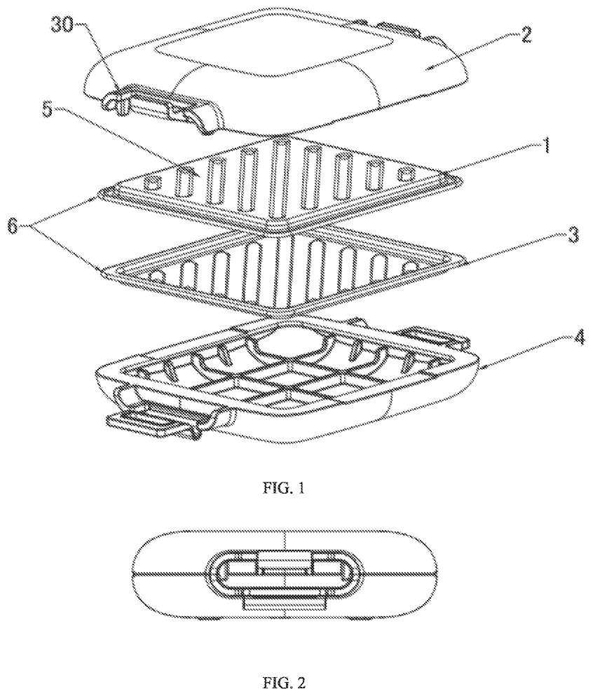

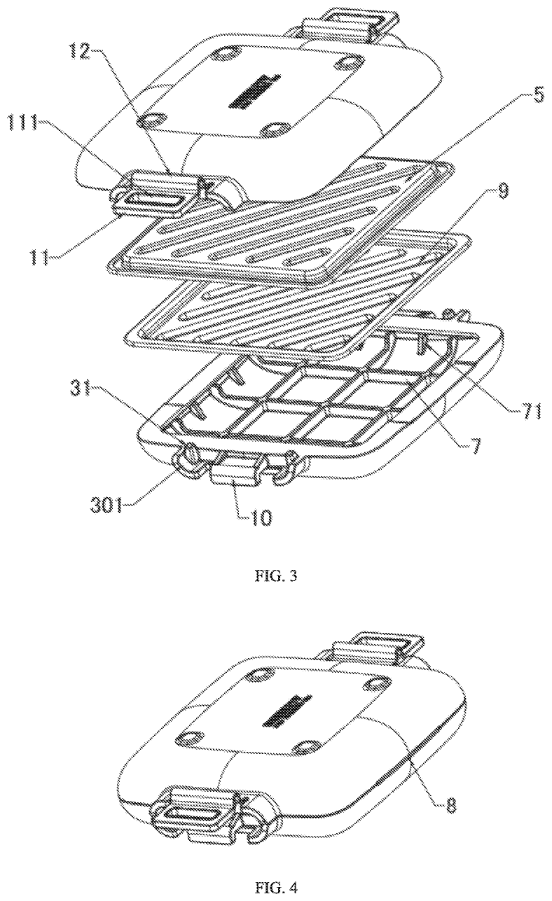

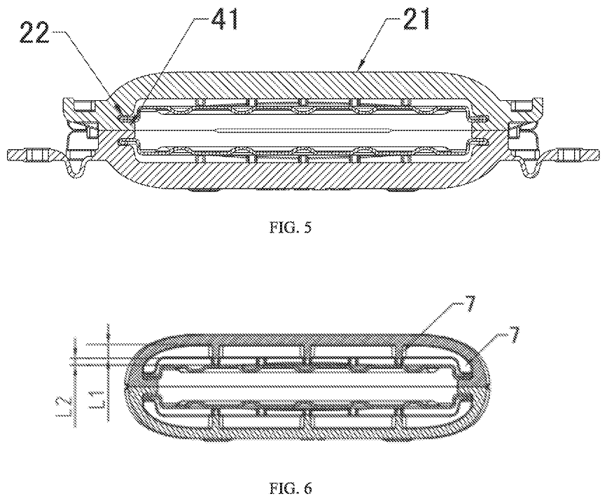

Referring to FIGS. 1 to 6, the present invention provides a microwave baking pan with a fully-enclosed structure. The microwave baking pan includes an upper baking pan 1 and an upper baking pan sheath 2, as well as a lower baking pan 3 and a lower baking pan sheath 4. The outer surfaces of the upper and lower baking pans are receptively provided with a microwave absorption layer 5 which is used to absorb electromagnetic waves emitted from a microwave oven and convert the electromagnetic waves into heat. Each of the upper and lower baking pans is provided with a flange 6. The upper baking pan sheath 2 and the lower baking pan sheath 4 are made of silica gen or soft plastic. Each of the upper baking pan sheath 2 and the lower baking pan sheath 4 includes a face cover part 21 and an edge cover part 41, both of which are integrally formed. A caulking groove 22 is also formed at a connection between the face cover part 21 and the edge cover part 41, and the flange 6 is inserted into the caulking groove 22. When the microwave baking pan is in use, the upper baking pan and the lower baking pan are stacked to face each other to form a flat cooking chamber. Due to the same contour and size of the upper and lower baking pan sheaths, when the upper and lower baking pans are stacked to face each other, the edge cover parts 41 are butted vertically to prevent the flanges 6 from colliding. A recess is respectively provided in the middle of each of the edge cover parts 41 on the left and right sides of the upper and lower baking pan sheaths 41, and the two recesses are butted to form a breathable notch 8.

An opening of each of the upper and lower baking pan sheaths is adapted to an outer edge contour of the flange of the baking pan, so that the upper and lower baking pans can be adaptively placed in the upper baking pan sheath or lower baking pan sheath. The upper and lower baking pans in the present embodiment are a pair of square or rectangular metal baking pans. Each of the upper baking pan sheath 2 and the lower baking pan sheath 4 is provided with fishmouth lifting lugs 30 on the front and rear sidewalls. In a case that the upper and lower baking pan sheaths are butted, the fishmouth lifting lugs are engaged to form a runway-shaped contour. Each fishmouth lifting lug is provided with a notch, an L-shaped convex buckle 10 is provided in the notch of the fishmouth hanging lug of the upper baking pan sheath, and an elastic fastener 11 is provided in the notch of the fishmouth hanging lug of the baking pan sheath.

Crisscrossed reinforcing ribs 7 are provided at the bottom inside each of the upper and lower baking pan sheaths, a groove rib 71 is provided between the adjacent two reinforcing ribs near the edge cover part, and the top of the groove rib 71 and the top of the end of the reinforcing rib 7 are both on a horizontal plane A. The horizontal plane A forms the caulking groove 22 with the wall of the edge cover part. The groove ribs 71 and the reinforcing ribs 7 support the upper and lower baking pans together. A metal main surface of each of the upper and lower baking pans is provided with a plurality of convex ribs 9. The food is placed on the convex ribs to prevent from being soaked by accumulated oil and water, making the food flavor better.

The L-shaped convex buckle 10 is provided on a sidewall where a retaining strip of the upper baking pan sheath is located, and the elastic fastener 11 paired with the L-shaped convex buckle is provided on a sidewall where a retaining strip of the lower baking tray sheath is located. The elastic fastener of the lower baking pan sheath may be buckled onto the L-shaped convex buckle of the upper baking pan sheath. The elastic fastener includes a fastening hole part 111 and a telescopic part, the telescopic part being a thin-walled U bend 12. The thickness of the thin-walled U bend 12 is ½ to ⅓ of the fastening hole part, and the thin-walled U bend 12 can be elastically deformed under an external force and then straightened, so that the fastening hole part tightly sleeves the L-shaped convex buckle, and the upper and lower baking pans are buckled into a whole to form a cooking utensils with two-sided heating.

A positioning column 31 is provided inside each of arc-shaped protection lugs 301 on both sides of the fishmouth lifting lug 30 of the upper baking pan sheath. Each positioning column is provided with a base part and a protruding part, wherein the base part extends out of a junction corner between the arc-shaped protection lug 301 and the baking pan sheath, and the protruding part is of an irregular terraced shape. The protruding part refers to a part that is higher than the edge cover part of the baking pan sheath. One sidewall of the protruding part is vertical, the other opposing wall thereof is arc-shaped, and this arc-shaped contour is adapted to an inner contour of the arc-shaped protection lug of the fishmouth lifting lug of the lower baking pan sheath, which facilitates guided positioning during the docking of the lower and lower baking pan sheaths.

Referring to FIG. 2 and FIG. 6, an outer contour of the upper and lower baking pan sheaths while in docking and closure is also in a runway shape, which is in cooperation with the outer contour of the fishmouth lifting lug. Therefore, the microwave baking pan is harmonious, generous and decent in overall appearance. Referring to FIG. 6, the reinforcing ribs 7 are distributed along the inner walls of the upper and lower baking pan sheaths and each have the approximately same rib height L1. A distance L2 between each of the upper and lower baking pans and each reinforcing rib 7 is about 1 to 2.5 cm, thereby forming an air troposphere, which is conducive to uniform heating of food.

What is claimed is:

1. A microwave baking pan with a fully-enclosed structure, comprising an upper baking pan, a lower baking pan, an upper baking pan sheath and a lower baking pan sheath, wherein the outer surface of each of the upper and lower baking pans is provided with a microwave absorption layer, and each of the upper and lower baking pan sheaths comprises a face cover part and an edge cover part; each of the upper and lower baking pan sheaths is respectively provided with a fishmouth lifting lug on the front and rear side walls; each fishmouth lifting lug is provided with a notch in which an elastic fastener or an L-shaped convex buckle is provided; a positioning column is provided inside an arc-shaped protection lug on each of both sides of the fishmouth hanging lug of the upper baking pan sheath; and each positioning column is provided with a base part and a protruding part, the protruding part extending into the fishmouth lifting lug of the lower baking pan sheath.

2. The microwave baking pan with a fully-enclosed structure according to claim 1, wherein the fishmouth lifting lugs are engaged to form a runway-shaped contour, and an outer contour of the upper and lower baking pan sheaths while decked and closed is also in a runway shape.

3. The microwave baking pan with a fully-enclosed structure according to claim 2, wherein a first sidewall of the protruding part is arc-shaped, and the first sidewall is adapted to an inner contour of the arc-shaped protection lug of the fishmouth lifting lug of the lower baking pan sheath.

4. The microwave baking pan with a fully-enclosed structure according to claim 3, wherein the elastic fastener comprises a fastening hole part and a telescopic part, the telescopic part being a thin-walled U bend.

5. The microwave baking pan with a fully-enclosed structure according to claim 4, wherein the thickness of the thin-walled U bend is ½ to ⅓ of the thickness of the fastening hole part.

6. The microwave baking pan with a fully-enclosed structure according to claim 4, wherein crisscrossed reinforcing ribs are provided on the bottom inside each of the upper and lower baking pan sheathes, and a distance L2 between each of the upper and lower baking pans and the upper end of each reinforcing rib is 1 to 2.5 cm.
